(19) United States
(12) Patent Application Publication
(10) Pub. No.: US 2018/0248332 A1
(43) Pub. Date: Aug. 30, 2018

(54) Laser frequency control and sensing system

(71) Applicant: Alex Dinovitser, Adelaide (AU)

(72) Inventor: Alex Dinovitser, Adelaide (AU)

(21) Appl. No.: 15/619,644

(22) Filed: Jun. 12, 2017

Related U.S. Application Data
(63) Continuation of application No. PCT/AU2015/050789, filed on Dec. 14, 2015.

(51) Int. Cl. H01S 3/13; H01S 3/23; H01S 3/11; G01S 7/497; G01S 17/88; G01N 21/25; G01N 21/39

(52) U.S. Cl. CPC H01S 3/13; H01S 3/2308; H01S 3/11; G01S 7/497; G01N 2021/394; G01N 21/255; G01N 21/39; H01S 3/1303; H01S 3/1304; G01S 17/88

(57) ABSTRACT

Spectroscopic Laser Radar is a technique for the remote sensing of atmospheric composition. One of the technical challenges with this technique is the absolute stabilization of two or more laser wavelengths, generation of powerful laser pulses, and calibration of the acquired data. This invention describes the stabilization of one laser relative to an absolute optical frequency reference [claims 1, 2], and the beat-frequency stabilization of any number of additional lasers using passive beat frequency references [claims 1, 2, 5]. It describes control system and timing elements [claims 3, 4] to ensure accurate stabilization of all wavelengths [claim 6, 7, 8]. It describes a calibration technique, and a specific calibration technique for atmospheric water vapor [claim 9, 10]. This invention identifies specific novel optical frequency or optical wavelength bands for the spectroscopic detection of Methane and water vapor [claims 12, 13, 14].

### FIELD OF THE INVENTION

This patent describes a novel design for a Differential Absorption Lidar (DIAL) which is a spectroscopic laser-radar remote sensing technology for the measurement of atmospheric composition. The described DIAL system uses a technique novel to the art for simultaneous stabilization of two or more laser wavelengths with respect to both absolute and relative frequency standards. Additional features can be added to this invention which further enhance performance, and a novel method of system timing and calibration is described. Therefore, this patent focuses primarily on the atmospheric remote sensing applications and makes claims that relate to the design, operation and calibration of a complete DIAL system. However, due to the wide applicability of laser technology, this invention may find applications in other fields of science and technology.

The present invention relates to the stabilization of two or more laser wavelengths. Furthermore, the present invention relates to the sensing of material species over specific ranges of optical frequencies (or wavelengths), and the simultaneous measurement of two or more species over a specific range of optical frequencies.

The present invention relates to sensing, remote sensing, laser cooling, confining and manipulating matter at the atomic scale and Terahertz frequency stabilization.

This invention presents an improved technique for stabilizing a first laser to a single atomic resonance.

The invention provides one or more of the following features:

An improved technique of beat-frequency stabilization of a second laser to the first laser with arbitrarily high beat frequencies that can themselves be stabilized to atomic resonances.

A novel method for control-system synchronization and pulse formation.

A novel method for Application and calibration of this system to Differential Absorption Lidar.

A novel method for humidity calibration

### BACKGROUND OF THE INVENTION

Laser frequency stabilization and the interaction of accurately and precisely controlled laser light with matter are important and rapidly emerging fields of science and technology. These have applications to sensing, remote sensing, laser cooling and heating, as well as the manipulation, separation and confinement of atoms in a laser beam.

### OBJECTS OF THE INVENTION

It is an object of this invention to provide at least one of the following advantages:
1. Stabilization of the wavelength of one single frequency laser to one atomic resonance line.
2. Offset stabilization of a second laser to the first laser.
3. Dither and pulse generation and synchronization with the wavelength stabilization systems.
4. Operation of a remote sensing lidar at spectral bands which were previously not considered feasible for remote sensing of specific molecular species.
5. A technique for the calibration of a DIAL system.
6. A novel method for remote sensing of water vapor and methane gas.
7. A novel method for low-cost in-situ absolute humidity measurement and calibration.

### SUMMARY OF THE INVENTION

Various techniques for stabilizing the wavelength of a single frequency laser are well known. This technology is important for sensing as well as for laser cooling and for manipulating matter at the atomic scale. However, the stabilization of a laser frequency requires the modulation of the said optical frequency. This frequency modulation also inevitably also produces some intensity modulation that results in a optical frequency error. The preferred embodiment of the present invention presents an improved ratiometric technique for the laser frequency stabilization that utilizes signal division instead of the signal normalization and subtraction as used in prior art.

Some applications of laser wavelength stabilization, including certain embodiment of LIght Detection And Ranging (LIDAR) such as DIfferential Absorption LIDAR (DIAL), as well as laser trapping and cooling, require a stabilized optical frequency with a precise offset from the molecular resonance frequency. The present invention provides an offset stabilization system does not require any dither modulation of the off-line lasers, and allows for the stabilization of an arbitrarily small optical offset between the on-line and off-line wavelengths. This is especially relevant to Differential Absorption Lidar (DIAL) where it is often desirable to use a side-line optical frequency that is stabilized close to, but not at the center of molecular resonance. The capability to produce an optical frequency that is continuous, stable, and precise is particularly interesting for nadir viewing DIAL systems.

The preferred embodiment of the present invention implements a novel offset wavelength stabilization scheme where two laser wavelengths are stabilized relative to each other without utilizing a local oscillator and RF mixer to measure the beat frequency, as described in prior art. This offset locking technique utilizes passive bandpass or bandstop electromagnetic filter elements instead of a local oscillator and mixer. The passive nature of the electromagnetic frequency reference means that gaseous vapors, liquids and metamaterials may be utilized as a beat reference. This technique is also applicable to beat frequency stabilization across a very wide frequency range, to produce stabilized frequency sources well into the Terahertz band of the electromagnetic spectrum.

Some applications of laser wavelength stabilization, including certain embodiments of LIght Detection And Ranging (LIDAR) such as DIfferential Absorption LIDAR (DIAL), also require the stabilized laser radiation to be transmitted in pulsed form, as well as the transmission of two or more stabilized wavelengths. The preferred embodiment of the present invention presents a method for stabilizing two or more single-frequency lasers that includes a synchronous and combined stabilization and optical switching method that produces fixed optical frequency pulses while maximizing the available optical power from a given system and minimizing any perturbation of the wavelength control systems.

The use of lasers for the remote sensing of atmospheric gases by differential absorption LIght Detection And Ranging (LIDAR) (DIAL) techniques is already known. All DIAL techniques involve the transmission of two or more wavelengths and measuring the different return signals. In a DIAL system, different magnitudes of scattering are caused by molecular resonant interactions with the propagating electromagnetic radiation, such that a closer match between the propagating electromagnetic (online) frequency and the natural frequency or frequencies of the molecule, result in a greater degree of scattering and attenuation, compared to a another electromagnetic (offline) frequency with a poorer match to the molecule's natural resonance frequency. Each molecular species has tens of thousands of distinct spectral features, where the typical width of each spectral line is of the order of several GHz at sea level. There are different types of DIAL that utilize the spectral features in different ways. One example utilizes multimode lasers with a broad linewidths of the order of 1 nm that interact with numerous natural resonances of the targeted molecule and an offline wavelength that is more than 1 nm away from the online wavelength. However, the preferred embodiment of the present invention utilizes a single frequency laser with a narrow linewidth that interacts with only a single natural resonance feature of the targeted molecule, and an offline wavelength that is less than 100 pm away from the online wavelength. One critical difference in performance between various DIAL systems can be attributed to the design frequency at which they operate because the resonance frequency is a critical aspect of the design of this type of DIAL system.

The absolute accuracy of a DIAL system depends on the knowledge of the precise spectroscopic parameters of the selected resonance line, as well as the spectral purity of the transmitted laser radiation. The present invention also overcomes a problem that the accuracy of the known and documented spectral parameters are poorly defined, and the spectral purity can be difficult to measure as a convolution with the spectral line shape. The present invention therefore presents a novel calibration technique that provides measurements that are traceable to absolute standards.

The present invention is generally directed to a type of LIght Detection And Ranging (LIDAR), however, since the present invention has as its primary object the provision of a method for the stabilization and transmission of specific laser wavelengths, it may also be directed towards the applications where two or more continuous laser wavelengths are stabilized. The present invention may also be directed towards the stabilization of optical beat frequencies where two or more continuous mode single frequency laser signals are linearly mixed or combined, and the resulting stabilized beat frequency is measured, utilized or transmitted in the form of electromagnetic waves.

For the specific detection and calibration of water vapor in the atmosphere, prior art includes optical devices for the measurement of the dew-point temperature (eg: U.S. Pat. No. 4,629,333). The present invention is directed to a non-optical realization of dew-point measurement where detection of dew formation is performed without free-space electromagnetic propagation of radiation, such as from a laser.

### BRIEF DESCRIPTION OF THE DRAWINGS

FIGS. 1A and 1B illustrate two embodiments of the present invention where FIG. 1A illustrates a general embodiment of the present invention illustrating the stabilization of multiple laser wavelengths with respect to laser 1, where laser 1 wavelength is stabilized to the natural frequency of 5. FIG. 1B illustrates a simpler embodiment where only two laser wavelengths are thus stabilized.

FIG. 2A to 2D illustrate sonic of the key elements of the present invention and how they relate to prior art. FIG. 2A illustrates the prior art eg: S. Schilt, L. Thevenaz and P. Robert, Wavelength modulation spectroscopy: Combined frequency and intensity laser modulation, in Applied Optics 33, 6728-6738 (2003) where signals from two detectors 6a and 6b, are amplified and subtracted such that they cancel out when there is no signal due to 5.

FIG. 2B illustrates an element of the present invention where signals from detectors 6a and 6b are amplified and divided, (not added or subtracted). In this design, no gain adjustments are necessary for cancellation when there is no signal due to 5.

FIG. 2C illustrates signals from detectors 6a and 6b are amplified and divided with a time delay 7 added to the signal at 6a to compensate for the time delay at 6b due to the finite speed of light through 5.

FIG. 2D illustrates another embodiment of the present invention without the element described in FIGS. 2B and 2C.

FIGS. 3A and 3B illustrate beat frequency stabilization systems where FIG. 3A illustrates prior art including S. Schilt, et. al. Laser offset-frequency locking up to 20 GHz using a low-frequency electrical filter technique, Appl. Opt. 47, 4336-4344 (2008). In prior art, the beat frequency is stabilized with respect to frequency of energy supplied by a local oscillator. FIG. 3B illustrates the preferred embodiment of the present invention.

In the present invention, illustrated in FIG. 3B, the beat frequency is stabilized with respect to the resonance of a passive element. This differentiates the present invention from prior art as it enable the stabilization of higher laser beat frequencies.

FIG. 4 illustrates a calibration system for atmospheric water vapor. A non-linear humidity sensing element senses the condensation of liquid water on its surface, and a signal is sent to regulate the temperature of the humidity sensing element to the temperature at which the dew begins to form. FIG. 4 illustrates two possible embodiments of this invention where the temperature of the nonlinear sensing element is measured by a separate thermometer, that may be located either side of the humidity sensor.

### DETAILED DESCRIPTION OF THE. PREFERRED EMBODIMENTS

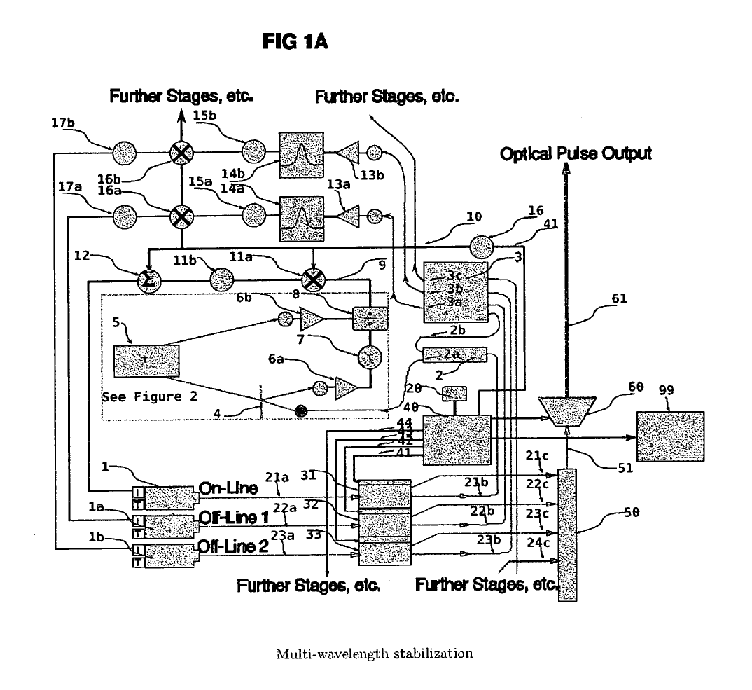

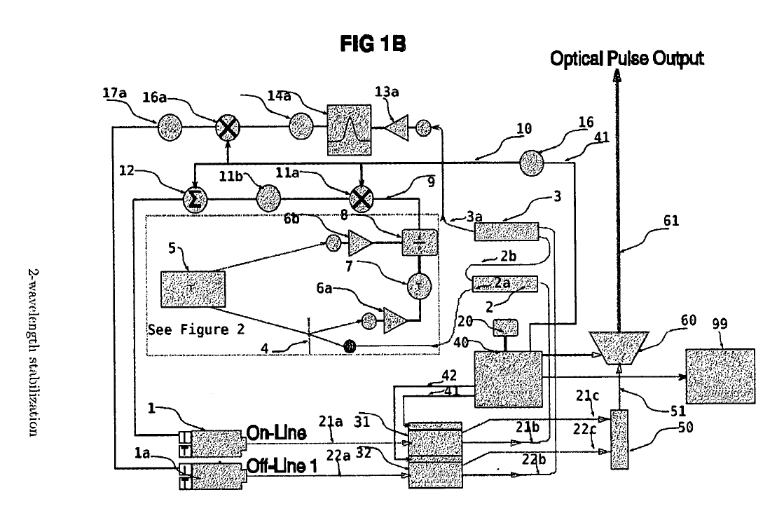

FIG. 1a illustrates one embodiment of the present invention illustrating stabilization of 3 or more wavelengths. In another embodiment of this invention, only two wavelengths are stabilized, as illustrated in FIG. 1b, where FIG. 1b is a simplified embodiment of FIG. 1a. Furthermore, the light may be guided by waveguides, it may propagate freely through space, or there may be combination of guided and free space alignments as illustrated in FIG. 1.

The output of lasers 1x (Laser 1a, Laser 1b, etc) may pass through additional optical components to improve spectral and geometric qualities of the beam. The output of lasers 1x may also modified by any optical frequency conversion device such as optical frequency doublers or optical parametric oscillators so as to multiply, divide, add or subtract optical frequency of the originating laser.

Some of the light from the On-line laser enters the light bandstop system after passing through the optical splitter 2. In one embodiment of the present invention, the light passes through the optical switch 31 before passing through the beamsplitter. In another embodiment of the present invention, the light passes through the beamsplitter 2 before passing through the optical switch 31.

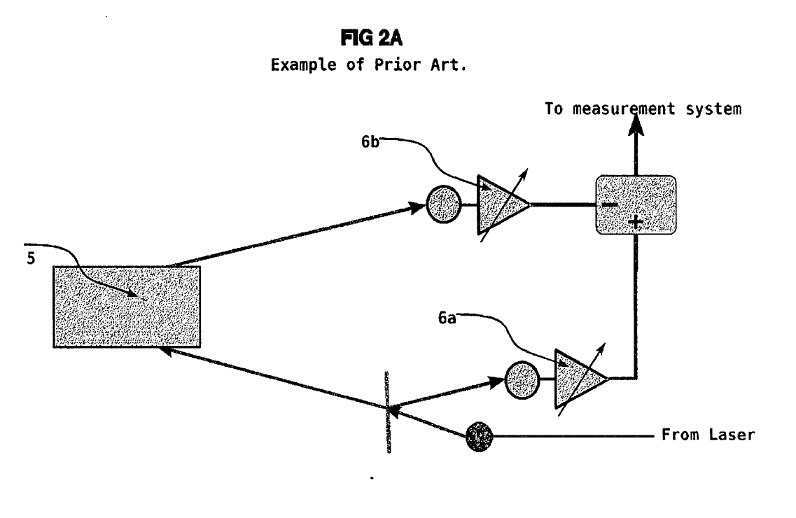

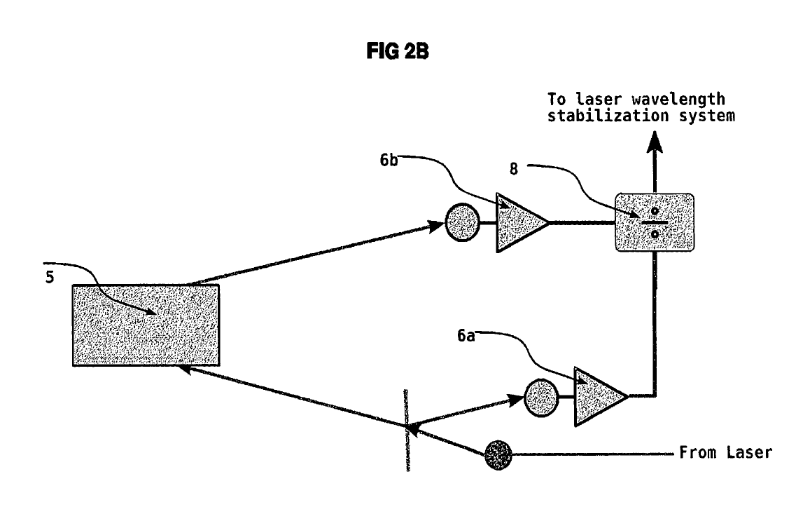

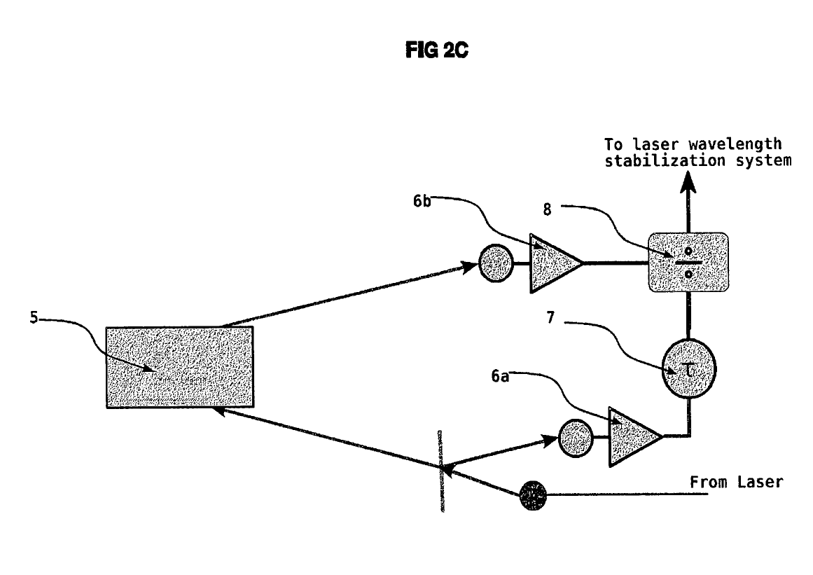

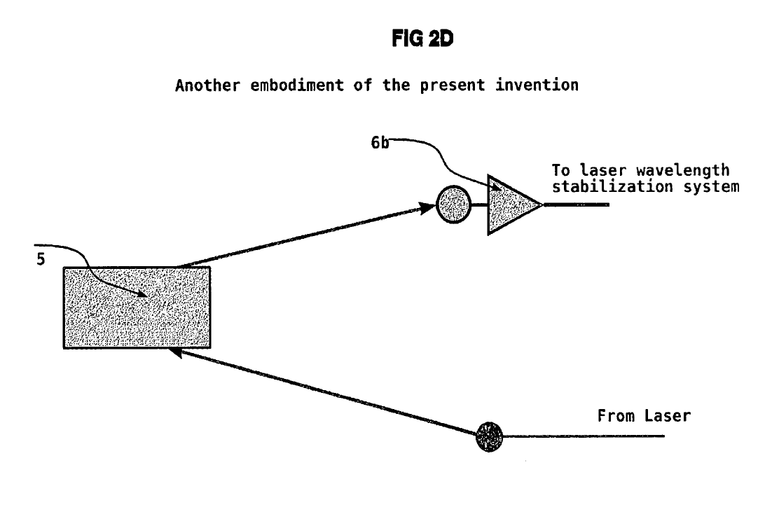

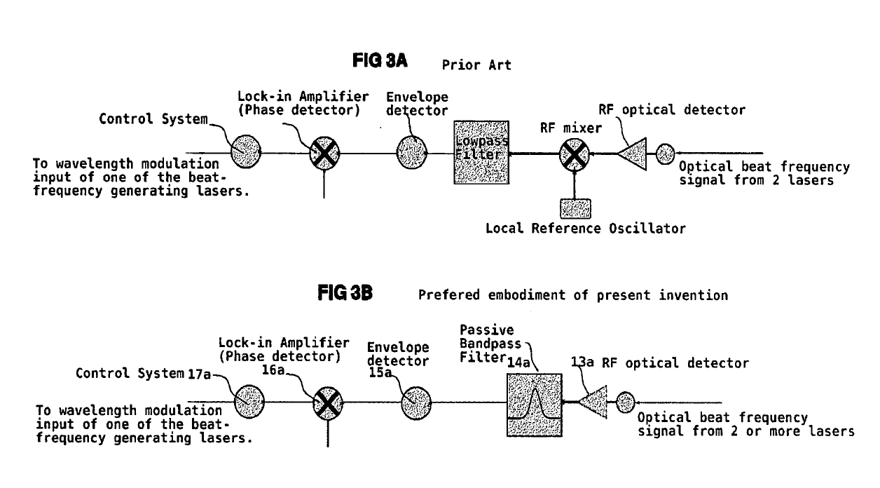

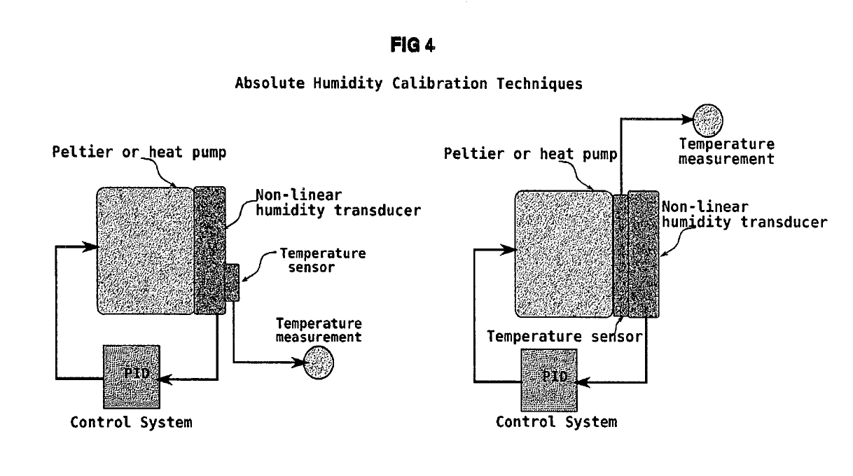

Some or all of the optical energy 21a is split into two paths by an optical splitter 2 with some of the output 2a entering a light bandstop sensor described in FIG. 2. Some of the on-line laser light 21a is switched by an optical switch 31 into two possible paths, 21b or 21c. In another embodiment of the present invention, the laser light frequency is sampled before entering the optical switching elements.

The optical signal 2a goes into the light bandstop sensor and is converted into an electrical signal 9, that may be obtained by any combinations of sensors and/or detectors 6x (6a, 6b, etc) as illustrated in FIG. 2. These sensors and/or detectors may also include analog to digital converters, in which case devices 11a, 11b and 12 may be implemented as digital software code. FIG. 2 illustrates prior art, as well as other embodiments of the light bandstop sensor.

The light bandstop system consists of a light bandstop filter 5 and detection electronics with various options described in FIG. 2. The light bandstop filter serves as an absolute wavelength calibration device because it absorbs light at wavelengths that correspond to transitions between energy levels of the material inside the light bandstop filter 5. In one embodiment of the present invention one or more reference cells are utilized as a light bandstop filter 5. In the preferred embodiment of the present invention, the free space aligned light ray interacts with a beamsplitter 4 before entering the light bandstop filter 5. Detectors 6a and 6b sample the amplitude of the optical energy before and after the light bandstop filter respectively. The detectors 6a and 6b may also include analogue to digital converters, in which case devices 7, 8, 11a, 11b and 12 may be implemented as digital software code. The light bandstop filter 5 may introduce a time delay τ due to the finite speed of light. In another embodiment of the present invention, a time delay 7 is added to the measured signal at 6a to compensate for the time delay at 6b. In the preferred embodiment of the present invention, the optical signals are instantaneously divided by each other 8. The signal at 6a may be the numerator and 6b may be the denominator. Alternatively, the signal at 6b may be the numerator and 6a the denominator. The result of the division produces the signal 9.

The resulting signal 9 is mixed with a dither signal 10 using a multiplier 11a to produce an error signal that is used to control the laser wavelength using a control system 11b. In the preferred embodiment of the present invention, the dither signal 10 is also added to the control signal by a device 12. However, the laser wavelength may be controlled and modulated by various means of injection present and/or temperature and/or cavity length and/or any other means that can be used to control and/or modulate a laser wavelength. The dither signal and the control signals are two separate signals. They may be electrically combined as illustrated in the figure or they may be utilized separately to alter the optical wavelength by different means. For example, in another embodiment of the present invention, the control signal from 11b goes to the temperature modulation input of the laser 1, and the dither signal 10 goes to the present modulation input of laser 1.

The dither signal is generated by 16 from a timing signal 41 that is generated by the timing distribution device 40. The timing distribution device 40 sources a master clock signal from device 20. The timing distribution device 40 may be constructed using digital circuitry or it may be implemented as digital software code. In addition to providing the reference clock for the dither signal generator 16, this device controls the optical switches 3x (3a, 3b, etc), the optical amplifier 60, as well as any external equipment such as data acquisition and receiving system 99. The dither signal 10 therefore originates from and is synchronous with the master clock oscillator 20, and is also synchronous with all the other timing functions performed by 40. In the preferred embodiment of the present invention, device 16 is a digital sine wave generator, that feeds bytecodes to a digital adder 12, with the result converted to an analogue signal by a D-A converter to provide a control present for laser 1. In another embodiment of the present invention, device 16 is an analogue double integrator that converts a square wave signal 41 to a sinusoidal signal 10 that is shifted by approximately 180° with respect to 41. In another embodiment of the present invention, the dither signal may undergo additional modification at 16 including filtering, integration, spectral shaping phase delay, etc.

In the preferred embodiment of the present invention, the optical switching occurs at a constant phase angle of the dither signal, as determined by the timing device 40. The phase angle at which switching occurs may be described by the equation ϕ=180.n+k where n is an integer and k is any constant. In the preferred embodiment of the present invention, k=0 and n=1, which means that a pulse is formed near the zero crossings of the dither signal voltage or current.

The preferred embodiment of the present invention includes one or more offline laser stabilization systems as illustrated in FIG. 1a. Each additional offline stabilization timing and control system includes all the elements of the first offline laser stabilization system that is described in this invention.

Some of the light front the on-line laser is linearly mixed with light from one or more off-line lasers to produce bear signals. In the preferred embodiment of the present invention, the optical outputs 3x carry all the beat frequencies of all the lasers present in the said system. The second optical output 2b from the optical splitter 2, goes to an optical splitter or mixer 3 with any number of inputs and outputs. This can be any optical device, or combination of optical devices that linearly mixes all the optical input signals 2xb (21b, 22b, etc) and 2b together and then splits the resulting optical energy into any number of outputs 3x, as illustrated in FIG. 1.

Detectors 13x (13a, 13b, etc) convert the optical signal containing the beat frequencies into an electrical signal. In the preferred embodiment of the present invention, a specific beat frequency is selected by a passive bandpass filter 14x (14a, 14b, etc) and rectified by detector 15x (15a, 15b, etc). In the preferred embodiment of the present invention, the detector 15x may also include an analogue to digital converter, in which case devices 16x (16a, 16b, etc) and 17x (17a, 17b, etc) may also be implemented as digital software code.

The offline laser wavelength is stabilized by measuring a beat frequency available from one of the optical outputs of device 3 against a bandpass filters 14x. The envelope of the signal from the bandpass filter 14x produced by detector 15x is multiplied by the dither signal using device 16x. The resulting error signal goes to a control system 17x that is used to control the laser wavelength. In the preferred embodiment of the present invention, no dither signal is added to the off-line lasers 1x, which means that these lasers are continuously stabilized without modulation, and their optical frequencies are held constant.

The optical output pulses 2xc (21c, 22c, etc) may be used directly for various applications where pulsed stabilized single frequency laser radiation is required. Alternatively, the optical outputs 2xc may be either combined or multiplexed by device 50. This may either consist of beamsplitters or mixers that combine the light from the outputs of all the switches. Alternatively, device 50 may be an active optical switching device that is controlled by device 40, that multiplexes one of the optical signals 2xc into the input of the optical amplifier 60. The output 61 from device 60 may be used to seed a higher power optical amplifier, or be used directly for some sensing application such as transmission through the atmosphere.

Where the present invention is applied to Differential Absorption Lidar (DIAL), the results may be calibrated using the optical bandstop sensor containing a known quantity of the measured gas. In the preferred embodiment of the present invention, the DIAL system described in FIG. 1 is re-arranged so that the laser pulses 61 pass through the optical bandstop sensor. The laser wavelength is scanned across the molecular resonance peak of the spectral feature that is being utilized for the DIAL measurement, using the laser light 61 that is otherwise transmitted through the atmosphere. As the laser wavelength is scanned across the spectral feature, the peak attenuation is measured and a calibration factor is calculated from this measurement and the delay τ of the optical bandstop filter. The DIAL instrument is then rearranged so that the pulses 61 are now transmitted through the atmosphere as illustrated in FIG. 1. The online and offline Lidar return data is substituted into the DIAL equation and the calibration factor is used in the DIAL equation to provide a quantitative measurement of the absolute number density of the targeted species in the atmosphere. For example, in the preferred embodiment of the present invention, the optical bandstop filter consists of a optical delay line that is open to the ambient air containing water vapor. The water molecule number density in the air is measured using a traceable calibrated relative humidity sensor and a traceable calibrated thermometer placed near the optical bandstop filter. From the relative humidity and temperature measurements, the water molecule number density in the optical bandstop sensor is calculated. The system is rearranged so that pulses 61 are transmitted through the optical bandstop sensor. The peak attenuation measurement and the length of the optical delay line is used to calculate a calibration factor. The instrument is then rearranged so that the pulses 61 are now transmitted through the atmosphere. The Lidar return data at two wavelengths is acquired. The DIAL equation used to calculate the water molecule number density in the atmosphere can now be calibrated using the calculated calibration factor.

The measurement of dew point is a well established technique for absolute humidity measurement and calibration. Prior art for this technique utilizes a laser or another optical source to detect dew formation by the scattering of electromagnetic radiation. The inventive step in the present invention is the realization that the measurement of electromagnetic radiation scattered by condensed water, is a type of a non-linear relative humidity transducer. The present invention is directed towards a novel dew-point thermometer where the non-linear relative humidity sensor consists of an electrical or electronic transducer, rather than optical transducer. FIG. 4 illustrates a heat pump attached to the said nonlinear electrical humidity transducer, the output of which is measured using a control system such that the temperature of the nonlinear humidity transducer is held constant near the dew point. A separate temperature measurement system transducer is mounted near the humidity transducer such that it is in good thermal contact with the humidity transducer. The signal from the temperature transducer is used to measure the temperature of the said humidity transducer. Two drawings in FIG. 4 illustrate different embodiments of the present invention where the temperature transducer and humidity transducer are held in good thermal contact with each other.

What is claimed:

1. A method of spectroscopic laser radar by stabilizing two wavelengths simultaneously using one optical frequency reference, and another passive or active beat frequency reference, where the first wavelength is stabilized to an optical frequency reference, and another wavelength is stabilized relative to the first wavelength using a passive or active beat frequency reference.

2. A method of claim 1 for stabilizing any number of optical wavelengths, where the first wavelength is stabilized to an optical frequency reference, and any number of other wavelengths are stabilized relative to the first wavelength using a passive or active beat frequency reference for every additional laser wavelength.

3. A method of claim 2 with pulse wavelength stabilization with a lock-in amplifier (synchronous amplification) such that the pulse is formed at a constant phase of the dither signal.

4. The method of claim 3, wherein an optical pulse is formed over a time interval that includes a zero phase (ie: zero crossing of the voltage waveform) of the dither signal. (A method of synchronous dither signal generation and optical switching that minimizes perturbation of the stabilized wavelength control system).

5. A method of claim 2 where the passive or active beat frequency reference consists of any type of bandpass or bandstop filter device in the electromagnetic frequency range of 100 MHz to 10 THz that couples into the circuit by transmission and/or reflection, in a guided (eg: waveguide) and/or unguided (eg: free space) configuration.

6. A method of claim 2 for improving the accuracy of an optical frequency reference in a system by utilizing a separate measurement of the instantaneous amplitude of the optical signal before and after the said reference, and dividing the instantaneous amplitudes of the two said signals.

7. A method of claim 6 where there is a timing delay between the two signals.

8. A method of claim 6, wherein the optical reference is a vacuum, a gas, a liquid, a solid, a plasma, or combinations thereof, in a single pass, multipath or a cavity, in a guided (eg: waveguide) and/or unguided (eg: free space) configuration.

9. A method of spectroscopic laser radar calibration utilizing dew-point measurement or calibration employing a nonlinear electronic or electrical humidity transducer in thermal contact with a temperature transducer.

10. A method of claim 2 for the calibration of a spectroscopic lidar system.

11. A method of claim 2 for the optical frequency stabilization for the master laser in a MOPA (Master Laser Power Amplifier) Differential Absorption LIDAR transmitter.

12. A method of claim 2 utilizing a specific laser wavelength for remote sensing of all isotopologues of water vapor by utilizing individual natural resonance frequencies over the following ranges of wavelengths:
585 nm to 595 nm
645 nm to 655 nm
693 nm to 697 nm
720 nm to 730 nm
815 nm to 835 nm
900 nm to 980 nm
1070 nm to 1230 nm
1300 nm to 1320 nm
1500 nm to 1550 nm
1640 nm to 1650 nm

13. A method of claim 2 utilizing a specific laser wavelength for remote sensing of all isotopologues of methane gas by utilizing individual natural resonance frequencies over the following ranges of wavelengths:
1120 nm to 1180 nm
1310 nm to 1330 nm
1640 nm to 1650 nm

14. A method of claim 2, wherein the optical frequencies fall into one of the narrow bands defined in claims 11 and 22, for the detection of the said gas species.
